(19) United States
(12) Patent Application Publication
(10) Pub. No.: US 2026/0298328 A1
(43) Pub. Date: Oct. 1, 2026

(54) PLANETARY TRANSMISSION, IN PARTICULAR FOR A MOTOR VEHICLE, AND A MOTOR VEHICLE

(71) Applicant: MERCEDES-BENZ GROUP AG, Stuttgart (DE)

(72) Inventors: Tobias HAERTER, Stuttgart (DE); Tobias SCHILDER, Ludwigsburg (DE); Peter HAHN, Stuttgart (DE)

(21) Appl. No.: 19/478,950

(22) PCT Filed: Mar. 22, 2024
(86) PCT No.: PCT/EP2024/057711

§ 371 Date: Oct. 27, 2025

(30) Foreign Application Priority Data
Apr. 28, 2023 (DE) 10 2023 001 724.8

(51) Int. Cl. F16H 57/023; F16H 57/04

(52) U.S. Cl. CPC F16H 57/023; F16H 57/043; F16H 57/0482

(57) ABSTRACT

A planetary transmission includes a housing, a planetary carrier forming a first shaft of the planetary transmission and which is rotatably mounted about a main axis of rotation and which has a pin carrier and planetary gear pins on which planetary gears are rotatably mounted. A claw coupling includes a first claw toothing permanently non-rotatably connected to the planetary carrier, which claw coupling is designed to non-rotatably connect the planetary carrier to a further shaft of the planetary transmission or to the housing. An oil-collecting ring is integrally formed with the first claw toothing and includes a flat lock washer integrally formed with the first claw toothing, which lock washer is designed to axially secure the planetary gear pins.

### BACKGROUND AND SUMMARY OF THE INVENTION

Exemplary embodiments of the invention relate to a planetary transmission in particular for a motor vehicle, as well as to a motor vehicle, in particular a car, having at least one such planetary transmission.

From DE 10 2016 216 789 A1 and DE 10 2019 008 948 A1, a planetary transmission is known in each case in which the claw toothing of a claw coupling are non-rotatably connected to a planetary carrier. DE 10 2009 001 985 A1 shows a planetary transmission, in which an engaging toothing of a coupling device is non-rotatably connected to a planetary carrier.

A lubrication device for a planetary transmission is known from DE 10 2019 205 760 A1, which has at least one planetary carrier having respective bearings for rotatably mounting one or more planetary gears.

Exemplary embodiments of the present invention are directed to a planetary transmission and a motor vehicle having at least one such planetary transmission, such that particularly high functional performance can be realized in a particularly space-saving manner.

A first aspect of the invention relates to a planetary transmission, in particular for a motor vehicle. This means that the motor vehicle, which is also simply referred to as a vehicle and is designed, for example, as a car, in particular as a passenger car, has the planetary transmission in its fully manufactured state and can be driven, for example, via the planetary transmission. In particular, it can be provided that the motor vehicle, in its fully manufactured state, has a drive device by means of which the motor vehicle can be driven. The drive device has the planetary transmission. By way of example, the drive device has at least one drive engine by means of which, for example, the motor vehicle can be driven via the planetary transmission. The drive engine can be an internal combustion engine, also known as a combustion engine, or an electric engine. In particular, at least or exactly two vehicle wheels of the motor vehicle can be driven by the drive engine via the planetary transmission, whereby the motor vehicle as a whole can be driven.

The planetary transmission has a housing and a planetary carrier, which forms a first shaft of the planetary transmission. In particular, the planetary carrier is at least partially arranged in the housing. The planetary carrier is mounted such that it can rotate relative to the housing about a main axis of rotation of the planetary transmission. The planetary carrier has a pin carrier and planetary gear pins. By way of example, the respective planetary gear pin is formed separately from the pin carrier and is fastened to the pin carrier, in particular in such a way that relative rotations between the respective planetary gear pin and the pin carrier are prevented and preferably in such a way that translational relative movements between the respective planetary gear pin and pin carrier in the axial direction of the respective planetary gear pin are prevented.

A respective planetary gear is mounted rotatably on the respective planetary gear pin, in particular precisely, such that the respective planetary gear is rotatable about a respective planetary gear axis of rotation relative to the respective planetary gear pin on which the respective planetary gear is rotatably mounted. In particular, it is provided that the respective planetary gear axis of rotation is spaced apart from the main axis of rotation and runs parallel to the main axis of rotation. In particular, the planetary gear pins are designed separately from one another. By way of example, the planetary gear axes of rotation are arranged on an imaginary circle, the center points of which lies, for example, on the main axis of rotation. By way of example, the planetary gear pins and thus, for example, the planetary gear axes of rotation are arranged consecutively and spaced apart from each other in the circumferential direction of the planetary gear running around the main axis of rotation and, in particular, are distributed evenly. In particular, the planetary gear has a sun gear and a ring gear, wherein it is specifically provided that the respective planetary gear meshes with the sun gear and with the ring gear, in particular simultaneously.

The planetary transmission has a claw coupling having a first claw toothing permanently non-rotatably connected to the planetary carrier. The claw coupling is designed to non-rotatably connect the planetary carrier to another shaft of the planetary transmission. This allows the claw coupling to be switched between a coupled state and a decoupled state, for example. In the coupled state, the planetary carrier and thus the first shaft are non-rotatably connected to the further shaft by means of the claw coupling, such that relative rotations between the further shaft and the planetary carrier or the first shaft, in particular about the main axis of rotation, do not occur. In the decoupled state, the claw coupling releases the planetary carrier and the further shaft for relative rotations, in particular about the main axis of rotation, such that, for example, in the decoupled state, the planetary carrier and thus the first shaft can rotate relative to the further shaft, in particular about the main axis of rotation.

Alternatively, the claw coupling is designed to non-rotatably connect the planetary carrier and thus the first shaft to the housing such that, for example, in the coupled state of the claw coupling, the planetary carrier and thus the first shaft are non-rotatably connected to the housing by means of the claw coupling and are therefore non-rotatably fixed to the housing. Thus, in the coupled state, relative rotations between the planetary carrier and the housing, in particular about the main axis of rotation, are prevented by means of the claw coupling. In the decoupled state, the claw coupling releases the planetary carrier and thus the first shaft for rotations, in particular about the main axis of rotation and relative to the housing.

The planetary transmission also has an oil-collecting ring, which is formed integrally with the first claw toothing. This is to be understood that the oil-collecting ring and the first claw toothing are formed from a single piece and are therefore formed by an integrally formed body, which is formed from a single piece and is therefore manufactured integrally and thus formed as monobloc. In other words, the first claw toothing and the oil-collecting ring are not formed separately from each other and connected to each other, but rather the oil-collecting ring and the first claw toothing are formed from a single piece and thus formed by a body that is formed integrally, i.e., formed from a single piece and designed as monobloc.

In order to implement a particularly wide range of functions in a particularly space-saving manner and thus to be able to represent a particularly compact design of the planetary transmission, a flat lock washer formed integrally with the first claw toothing is provided in accordance with the invention, which is designed to secure the planetary gear pins axially, i.e., in the axial direction of the planetary transmission, whose axial direction runs perpendicular to the radial direction of the planetary transmission and coincides with the main axis of rotation, in particular on the pin carrier. In other words, it is provided, for example, that the planetary gear pins are to be secured or are secured axially, in particular on the pin carrier, by means of the lock washer. The feature that the lock washer is a flat lock washer means in particular that at least one axial end face of the lock washer facing the planetary gear pin in the axial direction of the planetary transmission and thus along the main axis of rotation extends on a plane which extends perpendicular to the axial direction of the planetary transmission and thus perpendicular to the main axis of rotation, wherein, for example, the axial end face of the lock washer rests in the axial direction of the planetary transmission, in particular directly, against the planetary gear pin and, for example, also against the pin carrier, such that the planetary gear pins are secured axially, i.e., in the axial direction of the planetary transmission, to the pin carrier by means of the lock washer. This means that translational relative movements between the respective planetary gear pins and planetary carrier in the axial direction of the planetary transmission are prevented by means of the lock washer.

The feature that the lock washer is formed integrally with the first claw toothing means that the first claw toothing and the lock washer are not parts formed separately and connected to each other, but rather that the first claw toothing and the lock washer are formed from a single piece and thus consist of a body formed integrally, i.e., from a single piece, and thus integrally manufactured and designed as a monobloc body. This allows the number of parts, costs, space requirements and weight of the planetary transmission to be kept particularly low. It is apparent that the lock washer has a dual function. On the one hand, the lock washer is used to secure the planetary gear pins axially, in particular on a pin carrier. On the other hand, the lock washer is used to form the first claw toothing such that the planetary carrier can be non-rotatably connected in a form-fitting manner to the other shaft or the housing by means of the first claw toothing. This allows particularly high functional performance to be represented in a particularly space-saving, cost-effective and weight-efficient manner.

The main axis of rotation is an axis of rotation of the planetary carrier, which is rotatable about the axis of rotation relative to the housing. Unless otherwise specified, the terms “axial” and “radial” refer to the main axis of rotation. Thus, the term “axial” refers to the axial direction of the planetary transmission coinciding with the main axis of rotation, and the term “radial” refers to the radial direction of the planetary transmission perpendicular to the axial direction of the planetary transmission and thus perpendicular to the main axis of rotation.

In the context of the present disclosure, the feature that two components are non-rotatably connected to each other is to be understood as meaning that the non-rotatably connected components are arranged coaxially with each other and, in particular, when the components are driven, rotate together or simultaneously about an axis of rotation common to the components, such as the main axis of rotation, at the same angular velocity, in particular relative to the housing. The feature that two components are connected to each other in a torque-transmitting manner is to be understood as meaning that the components are coupled to each other in such a way that torques can be transmitted between the components, wherein, if the components are non-rotatably connected to each other, the components are also connected to each other in a torque-transmitting manner.

The feature that two components are permanently connected to each other in a torque-transmitting manner means that there is no switching element provided that can be switched between a coupling state, in which the components are connected to each other in a torque-transmitting manner, and a decoupling state, in which no torque can be transmitted between the components via the switching element, but rather that the components are always and thus permanently connected in a torque-transmitting manner, i.e., connected to each other in such a way that torque can be transmitted between the components. Thus, for example, one of the components can be driven by the other component or vice versa. In particular, the feature that two components are permanently non-rotatably connected to each other means that there is no switching element provided that can be switched between a coupling state, in which the components are non-rotatably connected to each other, and a decoupling state, in which the components are decoupled from each other and can rotate relative to each other, such that no torques can be transmitted between the components via the switching element, but rather the components are always, i.e., permanently, non-rotatably connected or coupled to each other. In other words, the term “non-rotatably” is to be understood as follows: two elements are non-rotatably connected to each other if they are arranged coaxially with each other, in particular with respect to their component axis of rotation, such as the main axis of rotation and/or with respect to an axis of rotational symmetry, and if they are connected to each other in such a way that they always rotate at the same angular velocity, in particular about the component axis of rotation. An element is non-rotatably connected to the housing if it cannot be rotated relative to the housing.

“Radially overlapping” is to be understood as follows: Two elements, in particular at least substantially rotationally symmetrical elements, are radially overlapping with respect to a common axis, such as the main axis of rotation, in particular arranged relative to each other, if they are at least partially arranged in the region of equal radial coordinates and, in particular, equal angular coordinates. “Axially overlapping” is to be understood in particular as follows: two elements are axially overlapping with respect to a common axis, such as the main axis of rotation, in particular arranged relative to each other, if they are at least partially arranged in a region of equal axial coordinates.

Preferably, the planetary carrier, in particular the pin carrier, is made of aluminum, for example die-cast aluminum.

The lock washer, the oil-collecting ring and the first claw toothing are advantageously parts of a combination component, also referred to as a combi-component.

Furthermore, it is particularly preferably provided that the lock washer, the oil-collecting ring and the first claw toothing are formed in one piece, particularly preferably in one piece made of steel.

The combination component, also referred to as a combi-component, serves on the one hand to axially secure the planetary gear pins and on the other hand to form the first claw toothing. Thirdly, the combination component advantageously serves to collect oil or lubricating oil.

In addition, the combination component and the planetary gear pins can be designed in such a way that the combination component serves to secure the planetary gear pins in a rotary manner. For this purpose, the planetary gear pins advantageously have projections in the axial direction which engage in corresponding receptacles of the combination component, thereby preventing the planetary gear pins from rotating about their own axis of symmetry (axis of rotational symmetry of the cylindrical planetary gear pins). It is important to prevent the planetary gear pins from rotating, as the planetary gear pins each have at least one through opening for transporting lubricating oil to a respective roller bearing, wherein the through openings must be arranged radially outside in relation to the main axis of rotation, where lubricating oil collects due to centrifugal forces.

The oil-collecting ring of the combination component can advantageously be designed in such a way that it also performs the function of the receptacles for the rotary securing of the planetary gear pins.

In order to implement a particularly advantageous functional performance in a particularly space-saving manner, one embodiment of the invention provides that the first claw toothing is directed radially outward with respect to the main axis of rotation, i.e., it extends outward in the radial direction of the planetary transmission or protrudes outward from a base body of the lock washer.

Another embodiment is characterized in that the pin carrier has a crown toothing. The crown toothing is thus arranged, for example, on a second axial end face of the pin carrier, whose second axial end face faces, for example, the lock washer in the axial direction. The lock washer has, for example, first recesses formed as through openings, which are penetrated by the crown toothing in the axial direction with respect to the main axis of rotation. In other words, the crown toothing engages in the first recesses in the axial direction of the planetary transmission, in particular in such a way that the first recesses are penetrated, in particular completely, by the crown toothing in axial direction of the planetary transmission. Thus, the lock washer is connected to the pin carrier in a form-fitting manner and, for example, non-rotatably by means of the crown toothing and the first recesses, whereby a particularly compact design of the planetary transmission can be represented.

In the scope of the present disclosure, ordinal numbers such as “first”, “second” etc. are not necessarily used to specify or imply a number or quantity of components to which the ordinal numbers refer, but rather to clearly reference terms to which the ordinal numbers are assigned, i.e. to which the ordinal numbers refer.

Another embodiment is characterized in that the crown toothing, i.e., in particular the toothing of the crown toothing, have second recesses which are arranged in the radial direction of the planetary transmission and thus extend in the radial direction. The second toothings are designed to accommodate a lock ring for axially securing the flat lock washer and the planetary gear pins. In other words, for example, the lock ring engages in the respective second recesses in the radial direction of the planetary transmission, such that, for example, the lock ring is fixed in the axial direction of the planetary transmission to the crown toothing and thus to the pin carrier. By means of the lock ring, the lock washer and, via this, the planetary gear pin are secured axially, i.e. in the axial direction of the planetary transmission, to the pin carrier, for example by the lock washer being able to be supported or being supported in the axial direction on the one hand on the lock ring and on the other hand on the respective planetary gear pin. This prevents excessive relative movements in the axial direction between the pin carrier and the respective planetary gear pin and between the lock washer and the pin carrier, such that advantageous axial securing can be represented in a particularly space-saving manner.

A further embodiment is characterized in that the flat lock washer has a circular shape arranged coaxially with the main axis of rotation, which forms, for example, the aforementioned axial end face of the lock washer. The planetary gear axes of the planetary gears intersect a circular arrangement common to the planetary gear axes, which is, for example, the aforementioned circle on which the planetary gear axes lie. The circular arrangement is arranged radially overlapping the lock washer, whereby a particularly compact design of the planetary transmission can be represented.

The oil-collecting ring is designed, for example, to catch oil that is thrown outwards in a radial direction from the planetary carrier and/or the respective planetary gear when the planetary carrier rotates around the main axis of rotation relative to the housing and/or the respective planetary gear rotates about the respective planetary gear axis of rotation relative to the respective planetary gear pin, and to direct it, for example, to the respective planetary gear pins, whereby the respective planetary gear pin can be advantageously oiled. Furthermore, the lock washer is used, for example, to protect the respective planetary gear pin from twisting, in particular relative to the pin carrier, and thus to protect it against twisting, in particular relative to the pin carrier, and thus to secure it against twisting, in particular relative to the pin carrier. This allows several advantageous functions to be combined in a single component in the form of the lock washer, resulting in a particularly compact design of the planetary transmission, and thus a particularly compact construction of the planetary transmission. Furthermore, it is possible to form the first claw toothing from hardened and/or nitride steel, from which the lock washer can be formed. This allows the first claw toothing to be made particularly robust. The pin carrier can be made of aluminum, for example, in particular by aluminum die casting, which keeps the weight of the planetary transmission particularly low.

In order to implement a particularly compact design of the planetary transmission, a radial bearing receiving region is provided in a further embodiment of the invention, which is formed integrally with the first claw toothing. In other words, the radial bearing receiving region and the first claw toothing are formed from a single piece. Thus, the radial bearing receiving region is formed by the lock washer. The radial bearing receiving region is designed to receive a radial bearing for radially bearing the planetary transmission on the housing. In other words, the radial bearing is preferably provided, by means of which the planetary carrier is rotatably mounted on the housing in the radial direction of the planetary transmission via the radial bearing receiving region and thus via the lock washer. The radial bearing is preferably designed as a roller bearing.

Finally, it has proven advantageous to provide an axial bearing receiving region that is formed integrally with the first claw toothing. Thus, the axial bearing receiving region and the claw toothing are formed from a single piece, such that the axial bearing receiving region is formed by the lock washer. The axial bearing receiving region is designed to accommodate an axial bearing for the axial mounting of the planetary carrier on the housing. Preferably, the axial bearing is provided by means of which the planetary carrier is rotatably mounted in the axial direction of the planetary transmission via the axial bearing receiving region and thus via the lock washer on the housing. Preferably, the axial bearing is designed as a roller bearing. This allows a particularly high functional performance of the lock washer to be implemented in a particularly compact manner.

A second aspect of the invention relates to a motor vehicle, also referred to simply as a vehicle and preferably designed as a car, in particular a passenger car, which has a drive device and can be driven by means of the drive device. The drive device has at least one planetary transmission according to the first aspect of the invention. Advantages and advantageous embodiments of the first aspect of the invention are to be regarded as advantages and advantageous embodiments of the second aspect of the invention, and vice versa.

Further advantages, features and details of the invention emerge from the following description of preferred exemplary embodiments and from the drawing. The features and combinations of features mentioned in the description above and the features and combinations of features mentioned in the description of figures below and/or only shown in the figures can be used not only in the combination indicated in each case, but also in other combinations or on their own without leaving the scope of the invention.

### BRIEF DESCRIPTION OF THE DRAWING FIGURES

The drawing shows in:

FIG. 1 in sections, a schematic longitudinal sectional view of a first embodiment of a planetary transmission; and

FIG. 2 in sections, a schematic longitudinal sectional view of a second embodiment of the planetary transmission; and

FIG. 3 in sections, a schematic perspective view of the planetary transmission; and

FIG. 4 in sections, a schematic front view of the planetary transmission.

In the figures, identical or functionally identical elements are provided with identical reference numerals.

### DETAILED DESCRIPTION

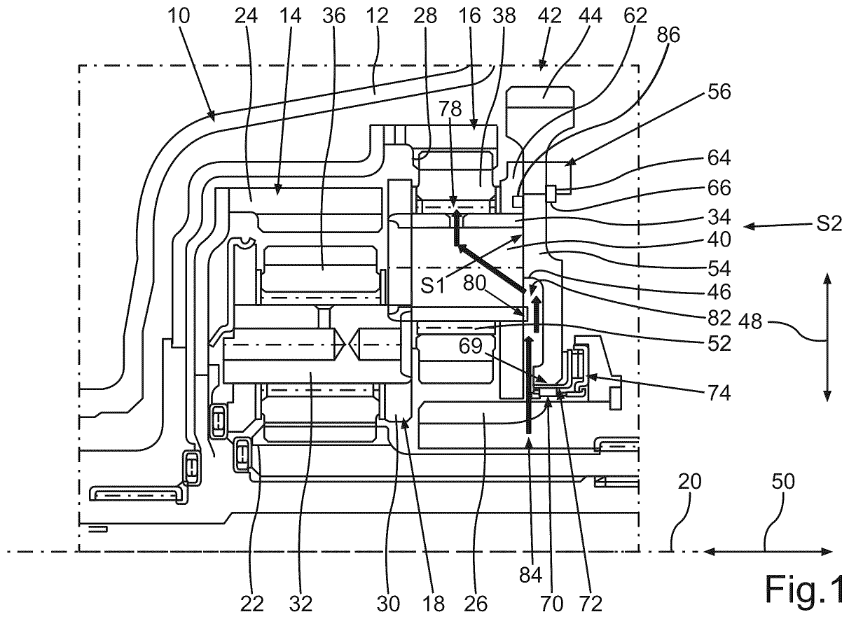

FIG. 1 shows, in sections, a schematic longitudinal sectional view of a first embodiment of a planetary transmission 10, in particular for a drive device of a motor vehicle. The planetary transmission 10 has a first planetary gear set 14 and a second planetary gear set 16, which are each arranged at least partially in the housing 12. The planetary transmission 10 has a planetary carrier 18 common to the planetary gear sets 14 and 16, which forms a first shaft of the planetary transmission 10 and is mounted so as to be rotatable about a main axis of rotation 20 relative to the housing 12. The first planetary gear set 14 has a first sun gear 22, which forms, for example, a second shaft of the planetary transmission 10. The planetary gear set 14 also has a first ring gear 24, which forms, for example, a third shaft of the planetary transmission 10. The planetary gear set 16 has a second sun gear 26, which forms, for example, a fourth shaft of the planetary transmission 10.

Furthermore, the planetary gear set 16 has, for example, a second ring gear 28, which forms, for example, a fifth shaft of the planetary transmission 10. The planetary carrier 18 has a pin carrier 30, first planetary gear pins 32 and second planetary gear pins 34. The first planetary gear set 14 has first planetary gears 36, wherein, in particular exactly, one of the planetary gears 36 in each case is rotatably mounted on, in particular exactly, one of the planetary gear pins 32 in each case.

The planetary gear set 16 has second planetary gears 38, wherein, in particular exactly, one of the planetary gears 38 in each case is rotatably mounted on, in particular exactly, one of the planetary gear pins 34 in each case, such that the respective planetary gear 38 is rotatably mounted on the respective planetary gear pin 34 about a respective planetary gear axis of rotation 40 relative to the respective planetary gear pin 34. It is also conceivable that third planetary gears are rotatably mounted on the planetary carrier 18. The respective planetary gear 36 meshes with the sun gear 22, but not with the ring gear 24. In addition, for example, in particular exactly, one of the planetary gears 36 meshes with, in particular exactly, one of the third planetary gears, wherein the respective third planetary gear meshes, for example, with the ring gear 24 and with the sun gear 26, but not with the sun gear 22 and not with the ring gear 28. In addition, the respective third planetary gear meshes with, in particular exactly, one of the planetary gears 38, wherein the respective planetary gear 38 meshes with the ring gear 28, but not with the sun gear 26.

The planetary transmission 10 has a claw coupling 42, which has a first claw toothing 44 permanently non-rotatably connected to the planetary carrier 18. The second shaft formed by the sun gear 22, the third shaft formed by the ring gear 24, the fourth shaft formed by the sun gear 26, and the fifth shaft of the planetary transmission 10 formed by the ring gear 28 are collectively referred to as planetary transmission shafts. By means of the claw toothing 44 and thus by means of the claw coupling 42, the planetary carrier 18 and thus the first shaft of the planetary transmission 10 can be non-rotatably connected to the housing 12 or to one of the planetary transmission shafts. For this purpose, the claw coupling 42, for example, has a second claw toothing that is not visible in the figures and is permanently non-rotatably connected to the housing 12 or to one planetary transmission shaft. By way of example, the claw coupling 42 can be switched between a coupled state and a decoupled state. In the coupled state, the claw toothings of the claw coupling 42 are at least indirectly connected to each other in a form-fitting manner, whereby the planetary carrier 18 is non-rotatably connected to the housing 12 or to the one planetary transmission shaft in a form-fitting manner. In the decoupled state, the claw toothings are decoupled from each other such that the planetary carrier 18 and thus the first shaft can rotate about the main axis of rotation 20 relative to the housing 12 or relative to the one planetary transmission shaft.

The planetary transmission 10 also has an oil-collecting element designed as an oil-collecting ring 46 in the present case, wherein the oil-collecting ring 46 is formed integrally with the first claw toothing 44. In FIG. 1, arrows illustrate the flow of oil through an oil guide 84. By way of example, when the sun gear 26 is rotated about the main axis of rotation 20 relative to the housing 12, oil is sprayed or thrown outwards from the sun gear 26 in the radial direction of the planetary transmission 10. The radial direction of the planetary transmission 10, whose axial direction is perpendicular to the radial direction of the planetary transmission 10, is illustrated by a double arrow 48. The axial direction of the planetary transmission 10 coincides with the main axis of rotation 20 and is illustrated by a double arrow 50. The oil thrown outwards in the radial direction of the planetary transmission 10 from the sun gear 26 or from the fourth shaft is collected by the oil-collecting ring 46 and directed to and, for example, into the respective planetary gear pins 34, by means of which, for example, the oil is directed, in particular via at least one radial through opening 78, to a respective bearing 52 designed, for example, as a roller bearing, by means of which the respective planetary gear 38 is rotatably mounted on the respective planetary gear pin 34. This supplies the respective bearing 52 with oil and thus lubricates it.

In order to implement particularly high functional performance in a particularly space-saving manner, the planetary transmission 10 has a flat lock washer 54 formed integrally with the first claw toothing 44. This means that the oil-collecting ring 46, the lock washer 54 and the claw toothing 44 are formed by a single-piece, i.e., integrally formed, combination component, which is also referred to as a combi-component and is formed from a single piece and is therefore integrally formed. In other words, the combination component is a body formed in one piece, i.e., manufactured from a single piece and thus integrally manufactured and therefore designed to be a monobloc body, which forms both the oil-collecting ring 46 and the claw toothing 44 and the lock washer 54. The lock washer 54 has an axial end face S1 facing the planetary gear pin 34 in the axial direction of the planetary transmission 10. Another function of the combination component is that the planetary gear pins 34 are secured to the pin carrier 30 in the axial direction of the planetary transmission 10 by means of the lock washer 54 and thus by means of the combination component. For this purpose, the axial end face S1, for example, lies in the axial direction of the planetary transmission 10, in particular directly, on the respective planetary gear pin 34.

It can be seen from FIG. 1 that the first claw toothing 44 is directed outwards in the radial direction of the planetary transmission 10. In addition, the pin carrier 30 has a crown toothing 56 formed on an axial end face S2 of the pin carrier 30. The axial end face S2 of the pin carrier 30 faces at least partially towards the lock washer 54 or the axial end face S1 in the axial direction of the planetary transmission 10. In other words, respective toothings of the crown toothing 56 protrude in the axial direction of the planetary transmission 10 from at least one side of the pin carrier 30 facing the axial end face S1 in the axial direction of the planetary transmission 10.

It can be seen from FIG. 1 that advantageously each planetary gear pin 34 has an extension 80. The extension 80 extends in the axial direction (double arrow 50) into a respective receptacle 82. The receptacles 82 for the extensions 80 of the planetary gear pins 34 are advantageously formed by the combi-component.

The receptacles 82 are non-rotatably connected to the lock washer 54.

The extension 80 and associated receptacles 82 are formed in such a way that the respective planetary gear pin 34 is prevented from rotating about its own axis of symmetry, such that the respective through opening 78 is always arranged radially outside in relation to the main axis of rotation 20 on the respective planetary gear pin.

The extension 80 is advantageously arranged axially overlapping the lock washer 54. Advantageously, the extension 80 extends from a respective cylindrical wall of the planetary gear pins 34.

It is particularly advantageous if the oil-collecting ring 46 is designed such that the receptacles 82 are formed as part of the oil-collecting ring.

In addition to the rotary securing of the planetary gear pins 34, there is another very important detail for the oil guide 84. A sealing ring 86 is arranged between the lock washer 54 and the pin carrier 30, such that the oil collected by the oil-collecting ring 46 is forced to flow into the planetary gear pins 34 and from there to the through openings 78.

The sealing ring 86 is designed to seal the combination component, in particular the lock washer 54, against the pin carrier 30. Advantageously, the sealing ring 86 is arranged radially outside the oil-collecting ring 46. Particularly advantageously, the sealing ring 86 is arranged radially outside the planetary gear pins 34 in relation to the main axis of rotation 20.

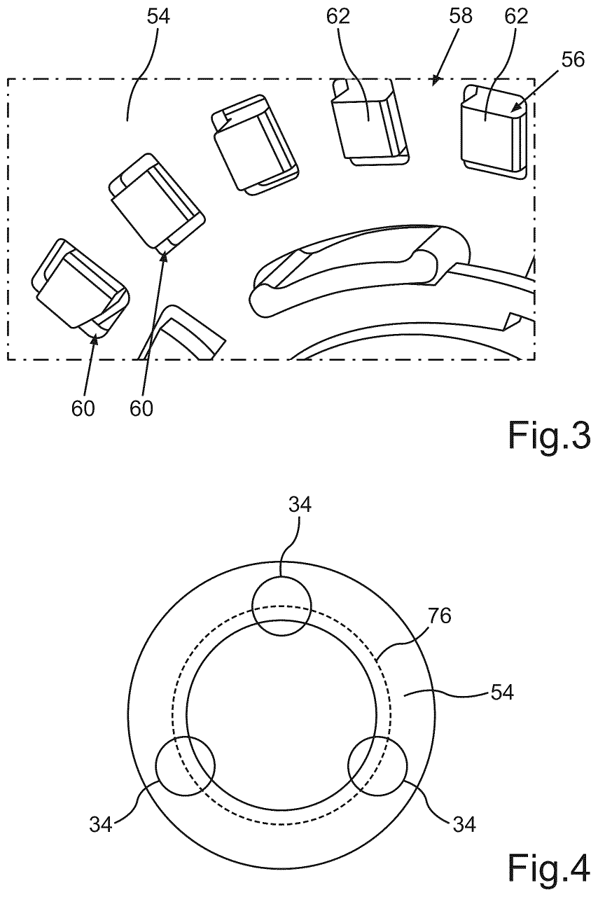

In conjunction with FIG. 3, it can be seen that the flat lock washer 54 and thus the combination component designated 58 has first recesses 60, which in this case are designed as through openings. The crown toothing 56, i.e., the teeth designated 62 of the crown toothing 56, engage in the recesses 60 in the axial direction of the planetary transmission 10, in this case in such a way that the recesses 60 are penetrated in the axial direction of the planetary transmission 10 by the crown toothing 56, and thus by the teeth 62. As a result, the combination component (combi-component 58) and the pin carrier 30 interact in a form-fitting manner, whereby, for example, the pin carrier 30 and the combination component 58 are non-rotatably connected to each other, namely in a form-fitting manner.

It can be seen from FIG. 1 that the crown toothing 56 has second recesses 64. By way of example, in particular exactly, one of the second recesses 64 is formed in each of the teeth 62. The respective second recess 64 is arranged in the radial direction of the planetary transmission 10. The recesses 64 accommodate a lock ring 66, which is formed separately from the combination component 58 and separately from the planetary carrier 18, by means of which the lock washer 54, and thus the combination component 58, and, in particular via the lock washer 54, the planetary gear pins 34 are axially secured to the pin carrier 30. For this purpose, the lock ring 66 is supported, for example, on an axial end face S3 of the lock washer 54, in particular directly, wherein the axial end face S3 is turned away from the axial end face S1 in the axial direction of the planetary transmission 10. In addition, the axial end face S1 is supported, for example, in the axial direction of the planetary transmission 10, in particular directly, on the respective planetary gear pin 34.

In the first embodiment, the combination component 58 has a radial bearing receiving region 69 formed integrally with the first claw toothing 44. The radial bearing receiving region 69 is mounted rotatably on the housing 12 in the radial direction of the planetary transmission 10 via a radial bearing 70, which is designed as a roller bearing in the present case, in particular via the fourth shaft. Thus, the planetary carrier 18 is rotatably mounted on the fourth shaft via the combination component 58, the radial bearing receiving region 69 and the radial bearing 70, and is rotatably mounted on the housing 12 via the fourth shaft. In addition, in the first embodiment, it is provided that the combination component 58 has an axial bearing receiving region 72, which is formed integrally with the first claw toothing 44. The axial bearing receiving region 72 is mounted at least indirectly on the housing 12 via an axial bearing 74, which is designed as a roller element in the present case, in particular via the fourth shaft, such that, for example, the planetary carrier 18 is mounted rotatably on the fourth shaft via the combination component 58, the axial bearing receiving region 72 and the axial bearing 74, and via the fourth shaft on the housing 12.

The axial bearing receiving region 72 is thus designed to receive the axial bearing 74. Advantageously, the axial bearing 74 is also designed for radial mounting of the axial bearing receiving region 72.

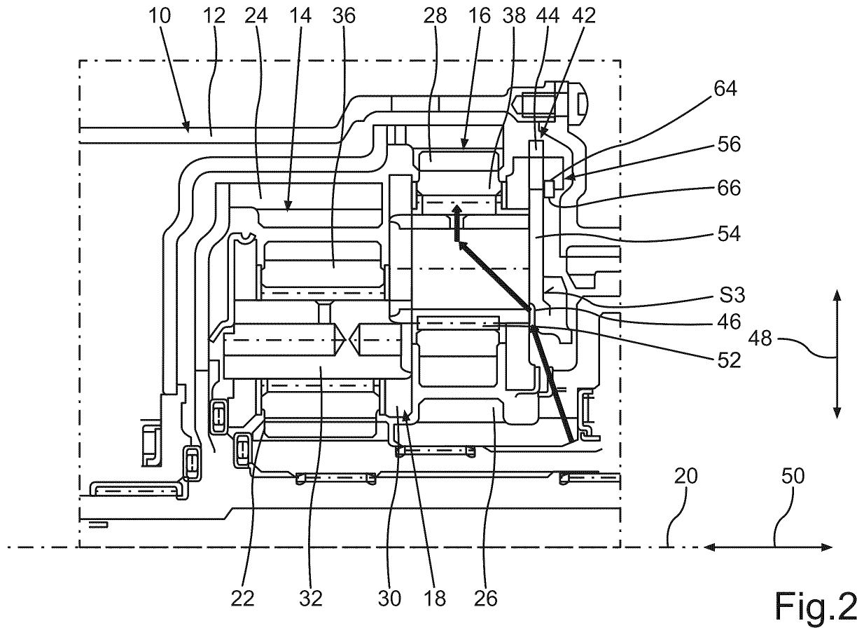

FIG. 2 shows, in a schematic longitudinal sectional view, a second embodiment of the planetary transmission 10.

It can be seen from FIG. 4 that the planetary gear axes of rotation 40 intersect a circular arrangement 76, the center of which lies, for example, on the main axis of rotation 20. The circular arrangement 76 is arranged radially overlapping the lock washer 54. Furthermore, it can be seen from FIG. 4, for example, that the flat lock washer 54 has a circular shape arranged coaxially with the main axis of rotation 20.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

Reference numeral list

| | |
|---|---|
| 10 | planetary transmission |
| 12 | housing |
| 14 | first planetary gear set |
| 16 | second planetary gear set |
| 18 | planetary carrier |
| 20 | main axis of rotation |
| 22 | first sun gear |
| 24 | first ring gear |
| 26 | second sun gear |
| 28 | second ring gear |
| 30 | pin carrier |
| 32 | planetary gear pin |
| 34 | planetary gear pin |
| 36 | planetary gear |
| 38 | planetary gear |
| 40 | planetary gear axis of rotation |
| 42 | claw coupling |
| 44 | first claw toothing |
| 46 | oil-collecting ring |
| 48 | double arrow |
| 50 | double arrow |
| 52 | bearing |
| 54 | lock washer |
| 56 | communication device |
| 58 | combination component |
| 60 | first recess |
| 62 | tooth |
| 64 | second recess |
| 66 | lock ring |
| 69 | radial bearing receiving region |
| 70 | radial bearing |
| 72 | axial bearing receiving region |
| 74 | axial bearing |
| 76 | circular arrangement |
| 78 | through opening |
| 80 | extension |
| 82 | receptacle |
| 84 | oil guide |
| 86 | sealing ring |
| S1 | axial end face |
| S2 | axial end face |
| S3 | axial end face |

1-10. (canceled)

11. A planetary transmission comprising:
a housing;
a planetary carrier forming a first shaft of the planetary transmission and rotatably mounted about a main axis of rotation, wherein the planetary carrier comprises a pin carrier and planetary gear pins on which planetary gears are rotatably mounted;
a claw coupling comprising a first claw toothing permanently non-rotatably connected to the planetary carrier, wherein the claw coupling is configured to non-rotatably connect the planetary carrier to a further shaft of the planetary transmission or to the housing;
an oil-collecting ring formed integrally with the first claw toothing; and
a flat lock washer integrally formed with the first claw toothing,
wherein the flat lock washer is configured to axially secure the planetary gear pins,
wherein the pin carrier has a crown toothing, and
wherein the flat lock washer has first recesses penetrated by the crown toothing in an axial direction with respect to the main axis of rotation.

12. The planetary transmission of claim 11, wherein the first claw toothing is directed radially outward with respect to the main axis of rotation.

13. The planetary transmission of claim 11, wherein the crown toothing has second recesses arranged in a radial direction and configured to receive a lock ring to axially secure the flat lock washer and the planetary gear pins.

14. The planetary transmission of claim 11, wherein the flat lock washer has a circular shape arranged coaxially with the main axis of rotation, wherein planetary gear axes of rotation of the planetary gears intersect a circular arrangement arranged perpendicular to the planetary gear axes of rotation and radially overlapping the flat lock washer.

15. The planetary transmission of claim 11, wherein the first claw toothing has an integrally-formed radial bearing receiving region configured to receive a radial bearing to radially bear the planetary carrier.

16. The planetary transmission of claim 11, wherein the first claw toothing has an integrally-formed axial bearing receiving region configured to receive an axial bearing to axially bear the planetary carrier.

17. The planetary transmission of claim 11, wherein the planetary gear pins each have an extension in the axial direction, wherein each extension engages in a receptacle non-rotatably connected to the flat lock washer.

18. The planetary transmission of claim 11, further comprising:
a sealing ring configured to seal the flat lock washer against the pin carrier.

19. A motor vehicle comprising:
a drive device configured to drive the motor vehicle, wherein the drive device has at least one planetary transmission comprising
a housing;
a planetary carrier forming a first shaft of the planetary transmission and rotatably mounted about a main axis of rotation, wherein the planetary carrier comprises a pin carrier and planetary gear pins on which planetary gears are rotatably mounted;
a claw coupling comprising a first claw toothing permanently non-rotatably connected to the planetary carrier, wherein the claw coupling is configured to non-rotatably connect the planetary carrier to a further shaft of the planetary transmission or to the housing;
an oil-collecting ring formed integrally with the first claw toothing; and
a flat lock washer integrally formed with the first claw toothing,
wherein the flat lock washer is configured to axially secure the planetary gear pins,
wherein the pin carrier has a crown toothing, and
wherein the flat lock washer has first recesses penetrated by the crown toothing in an axial direction with respect to the main axis of rotation.
